(19) United States
(12) Patent Application Publication
(10) Pub. No.: US 2007/0080779 A1
(43) Pub. Date: Apr. 12, 2007

(54) SYSTEM AND METHOD FOR REMOTELY CONTROLLING A FUNCTION

(75) Inventors: Tom Q. Tang, Novi, MI (US); John Nantz, Brighton, MI (US); Ronald O. King, Brownstone, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/163,259

(22) Filed: Oct. 12, 2005

(51) Int. Cl. G05B 19/00

(52) U.S. Cl. 340/5.61; 340/5.72; 340/825.69

(57) ABSTRACT

A system and method for remotely controlling a function. The system includes a transmitter and a receiver. The transmitter transmits a first signal portion at a first frequency deviation level and transmits a second signal portion at a second frequency deviation level when a range-limited function is requested.

### BACKGROUND OF THE INVENTION

### Field of the Invention

The present invention relates to a system and method for controlling a function, such as a vehicle function.

### SUMMARY OF THE INVENTION

In at least one embodiment of the present invention, a system for remotely controlling a function is provided. The system includes a transmitter and a receiver. The transmitter is configured to transmit a wireless control signal having first and second signal portions when a function is requested. The receiver is configured to receive the wireless control signal. The transmitter transmits the first signal portion at a first frequency deviation level and transmits the second signal portion at a second frequency deviation level when a range-limited function is requested.

In at least one other embodiment of the present invention, a method of controlling a function is provided. The method includes the steps of generating a wireless control signal with a transmitter, the wireless control signal having first and second signal portions, transmitting the first signal portion at a first frequency deviation level, transmitting the second signal portion at the first frequency deviation level when a range-limited function is not requested, transmitting the second signal portion at a second frequency deviation level when a range-limited function is requested, and performing the function if a receiver detects and successfully decodes the first and second signal portions.

In at least one other embodiment, a method of controlling a vehicle function with a remote keyless entry system is provided. The remote keyless entry system has a receiver disposed on a vehicle and a remote keyless entry fob. The remote keyless entry fob includes a transmitter and first and second input devices. The method includes the steps of actuating at least one of the first and second input devices, transmitting a first wireless control signal at a first frequency deviation level with the transmitter when the first input device is actuated, transmitting first and second signal portions of a second wireless control signal at first and second frequency deviation levels, respectively, when the second input device is actuated, implementing a first vehicle function when the first wireless control signal is received by the receiver and successfully decoded, and implementing a second vehicle function when the second wireless control signal is received by the receiver and successfully decoded. The first frequency deviation level provides greater receiver sensitivity than the second frequency deviation level.

### BRIEF DESCRIPTION OF THE DRAWINGS

FIG. 1 is a schematic diagram of a system for remotely controlling a function according to one embodiment of the present invention.

FIG. 2 is a schematic diagram of a transmitter control circuit for generating a wireless electronic signal.

FIG. 3 is a schematic diagram of a receiver control circuit for receiving the wireless electronic signal.

FIG. 4 is a simplified graphical representation of the wireless electronic signal.

FIG. 5 is a flowchart of a method for controlling a function according to one embodiment of the present invention.

FIG. 6 is a graphical depiction of a plurality of zones associated with the control of a function.

### DETAILED DESCRIPTION

Detailed embodiments of the present invention are disclosed herein; however, it is to be understood that the disclosed embodiments are merely exemplary of the invention and may be embodied in various and alternative forms. The figures are not necessarily to scale, some features may be exaggerated or minimized to show details of particular components. Therefore, the specific structural and functional details disclosed are not to be interpreted as limiting, but merely as a representative basis for the claims and/or as a representative basis for teaching one skilled in the art to variously employ the present invention.

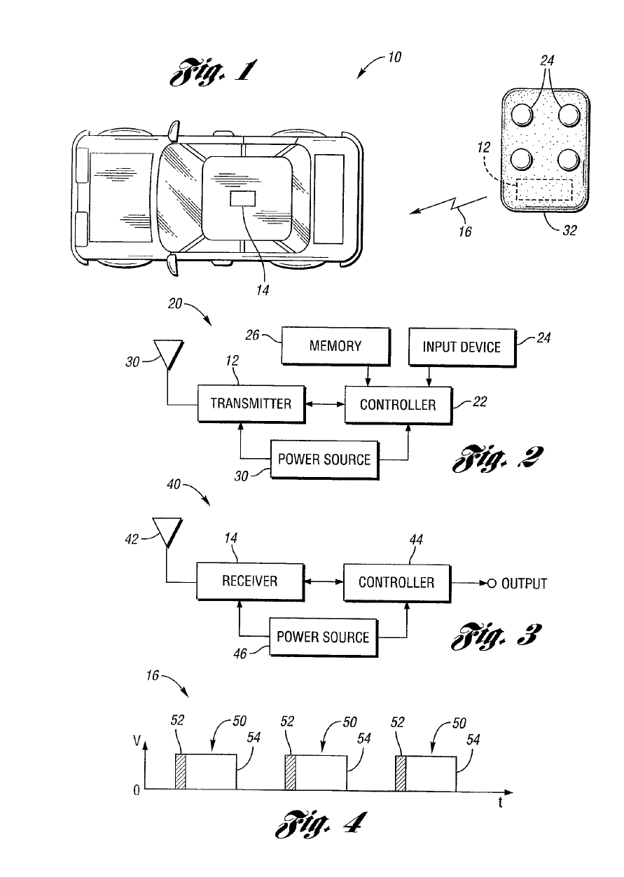

Referring to FIG. 1, a schematic diagram of a system 10 for remotely controlling a function is shown. In the embodiment shown, the system 10 is configured as a remote keyless entry system for a motor vehicle. Although the system 10 is primarily described in a vehicle context, it is contemplated that the invention may be implemented to control any appropriate function in connection with any appropriate system and/or device.

The system 10 may include a transmitter 12 and a receiver 14. The transmitter 12 may be remotely located from the receiver 14 and may be electronically coupled (i.e., in electronic communication) with the receiver 14 via a wireless electronic signal 16. Moreover, the transmitter 12 and receiver 14 may be configured for unidirectional or bidirectional communication.

The system 10 may be configured as an active or passive system. In an active system, an operator actuates an input device, such as a switch or button, to perform a desired function, such as locking or unlocking a vehicle door. In a passive system, actuation of an input device is not needed to perform a desired function. Instead, a function may be automatically performed as the transmitter 12 approaches or moves away from the receiver 14. For instance, in an embodiment having a vehicle-mounted receiver, a vehicle door may be automatically locked when the transmitter 12 is brought sufficiently close to the vehicle and may be automatically unlocked as the transmitter 12 moves away from the vehicle.

Referring to FIG. 2, an exemplary transmitter control circuit 20 is shown. The transmitter control circuit 20 may include the transmitter 12, a transmitter controller 22, at least one input device 24, a memory device 26, an antenna 28 for communicating the wireless control signal 16, and a power source 30 for powering one or more aspects of the transmitter control circuit 20.

The transmitter 12 may be any suitable electronic device capable of generating the wireless electronic signal 16, such as a transponder, transceiver, or the like. The transmitter 12 may generate the wireless electronic signal 16 at one or more power levels and at one or more frequencies or frequency deviations as will be discussed in more detail below. In the embodiment shown in FIG. 1, the transmitter 12 is part of a handheld remote control unit 32, commonly referred to as a “fob”. Alternatively, the transmitter 12 may be part of an ignition key head or any other suitable remote control device.

The transmitter controller 22 may control the generation of the wireless control signal 16 by the transmitter 12. In an embodiment configured as an active system, the transmitter controller 22 may receive an input signal from one or more input devices 24 and facilitate the generation of a specific wireless control signal or a portion thereof based on the input signal.

Referring to FIG. 3, an exemplary receiver control circuit 40 is shown. The receiver control circuit 40 may include the receiver 14, an antenna 42, a receiver controller 44, and a power source 46 for powering one or more aspects of the receiver control circuit 40.

The receiver 14 may be any suitable electronic device capable of receiving the wireless electronic signal 16 from the transmitter 12. For instance the receiver 14 may be configured as a transceiver or transponder. In at least one embodiment, the receiver 14 may receive the wireless electronic signal 16 via the antenna 42. The transmitter 12 may be disposed on a vehicle and may be directly or indirectly electronically coupled to one or more systems or devices that may execute a function.

The receiver controller 44 may control the decoding of the wireless control signal 16. More specifically, the receiver controller 44 may be electronically coupled to the receiver 14 and may decode, demodulate, or decipher the wireless electronic signal 16 or a portion thereof so that a requested function may be determined. The receiver controller 44 may be electronically coupled to one or more systems or devices that may execute a function. For example, the receiver controller 44 may provide an output signal to one or more actuators or electronic devices to control execution of a function. In a vehicular context, these functions may include, but are not limited to actuating a window, actuating a vehicle closure (e.g., door or convertible top), actuating a locking mechanism for a vehicle closure like a door or trunk, and operating an ignition system, alarm system, and/or interior or exterior lights.

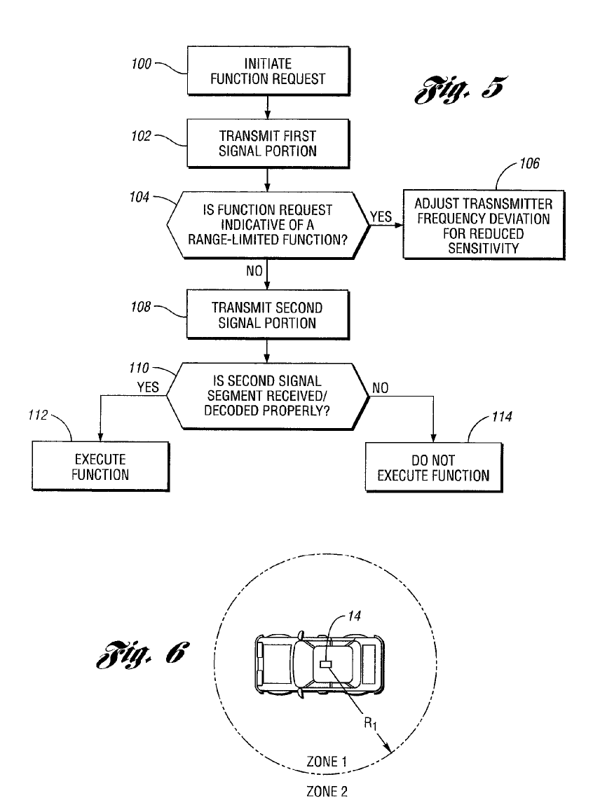

Referring to FIG. 4, a simplified representation of an exemplary wireless electronic signal 16 is shown. The wireless electronic signal 16 may include a message 50 that may be transmitted one or more times by the transmitter 12. The message 50 may be provided in any suitable format and may include a first signal portion 52 and a second signal portion 54. The first signal portion 52 may include a request for a function and may be provided at any suitable point of the message 50. In FIG. 4, the first signal portion 52 is provided at the beginning of the message 50 and prior to the second signal portion 54. Alternatively, the first signal portion 52 may be provided at an intermediate point or end of the message 50. Alternatively, the first and second signal portions may be provided as separate messages. As such, the first signal portion or first message (which may contain function identification information) and the second signal portion or second message may be sent at the same or different frequency deviations as will be discussed in more detail below.

Referring to FIG. 5, a flowchart of a method for controlling a function according to one embodiment of the present invention is shown. As will be appreciated by one of ordinary skill in the art, the flowchart represents control logic which may be implemented using hardware, software, or a combination of hardware and software. The control logic may be implemented using any of a number of known programming or processing techniques or strategies and is not limited to the order or sequence illustrated. For instance, interrupt or event-driven processing may be employed in real-time control applications, rather than a purely sequential strategy as illustrated. Likewise, pair processing, multitasking, or multi-threaded systems and methods may be used to accomplish the objectives, features, and advantages of the present invention.

This invention is independent of the particular programming language, operating system processor, or circuitry used to develop and/or implement the control logic illustrated. Likewise, depending upon the particular programming language and processing strategy, various functions may be performed in the sequence illustrated at substantially the same time or in a different sequence while accomplishing the features and advantages of the present invention. The illustrated functions may be modified or in some cases omitted without departing from the spirit or scope of the present invention.

The method may inhibit the execution of one or more functions based on the location of the transmitter 12 relative to the receiver 14. A graphical depiction of this concept is shown in FIG. 6. In FIG. 6, a plurality of zones are shown relative to a vehicle-mounted receiver 14. For simplicity, two zones (designated “zone 1” and “zone 2”) are shown, although any suitable number of zones may be provided. The zone closest to the vehicle (zone 1) is located within a predetermined distance (R1) from the receiver 14. The second zone (zone 2) extends beyond R1 and may be limited by the communication range of the system. One or more functions may be enabled when the transmitter is within zone 1 and disabled when the transmitter is outside zone 1 or vice versa. Similarly, other functions may be performed when the transmitter is in zone 1 or zone 2.

At 100, the method may begin when execution of a function is requested. In an active system, execution of a function may be requested using the input device as previously described. In a passive system, execution of a function may be based on a change in position of the transmitter relative to the receiver.

At 102, a first signal portion is generated and transmitted a first frequency deviation level. The first frequency deviation level may be configured to provide high receiver sensitivity. The first signal portion may be at least a portion of the wireless electronic signal or sequence of wireless electronic signals that form a complete function request or “message”. For example, the first signal portion may include encoded information that identifies the transmitter and the function or functions being requested. The first signal portion may be generated and transmitted using the transmitter and may be received by the receiver as previously described. Moreover, the first signal portion, if received, may be decoded using the receiver controller and/or another logical device in electronic communication with the receiver to identify the requested function.

At 104, the method determines whether a range-limited function has been requested. A range-limited function is a function that may be executed when the transmitter is within a predetermined distance or range from the receiver. For example, functions such as unlocking a vehicle closure, actuating a vehicle closure, or actuating a vehicle window may only be permitted when the transmitter is sufficiently close to the receiver. Other functions, such as locking a closure, remote engine startup, activating internal and/or external vehicle lights, and/or activating an alarm system or “panic” function may not be range-limited. Of course, these designations are merely exemplary; designation of a function as being range-limited or not range-limited may vary depending on design requirements. The determination as to whether a function is range-limited may be accomplished in any suitable manner. For example, a lookup table may be used to store a list of functions and their associated range designations in a manner known by those skilled in the art. If the function request is indicative of a range-limited function, then the method continues at block 106. If the function request is not indicative of a range-limited function, then the method continues at block 108.

At 106, the frequency deviation of the transmitter is adjusted to a second frequency deviation level. For example, the second frequency deviation level may be closer to a signal cutoff frequency than the first frequency deviation level. The second frequency deviation level provides a reduced level of receiver sensitivity as compared to the first frequency deviation level, thereby providing sub-optimal receiver performance and a decrease in the effective signal range. As such, a signal broadcast at the second frequency deviation level may not be properly received and/or decoded by the receiver when the transmitter is not within a predetermined distance of the receiver.

At 108, a second signal portion is generated and transmitted at an appropriate frequency deviation level. More specifically, the second signal portion is transmitted at the first frequency deviation level if the requested function is not range-limited and transmitted at the second frequency deviation level if the requested function is range-limited. The second signal portion may be at least a portion of an electronic signal or sequence of electronic signals that form a complete function request or “message”. For example, the second signal portion may be a portion of a message as shown in FIG. 4 or at least a portion of another message.

At 110, the second signal portion, if received, is decoded. The second signal portion may be decoded in any suitable manner, such as with the receiver controller and/or another logical device in electronic communication with the receiver. The receiver controller and/or other logical device may determine if the control signal portion was successfully decoded. If the second signal portion is received and successfully decoded, then the transmitter is within a predetermined distance from the receiver and the function may be executed at block 112. If the second signal portion is not received or is not successfully decoded, then the transmitter is not within the predetermined distance from the receiver and the function is not executed at block 114.

The present invention may allow one or more functions to be executed or inhibited based on frequency deviation and/or receiver sensitivity characteristics rather than by calculating the strength or power of a signal from the transmitter, thereby avoiding the complexities associated with determining the power of a signal. In addition, the present invention may allow execution of a function to be tailored to manufacture or customer requirements. For example, a controller may perform door lock and/or unlock functions when the transmitter is within a predetermined radius of the receiver. By performing a door lock/unlock function only when the remote transmitter is determined to be within a predetermined radius of the receiver, the method may reduce the likelihood that an operator may unintentionally lock/unlock a vehicle door from a far distance. Moreover, in at least one embodiment, the present invention may allow multi-range control of various devices using conventional remote keyless entry system components, thereby yielding little cost impact.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for remotely controlling a function, the system comprising:
a transmitter for transmitting a wireless control signal when a function is requested, the wireless control signal including a first signal portion and a second signal portion; and
a receiver for receiving the wireless control signal;
wherein the transmitter transmits the first signal portion at a first frequency deviation and transmits the second signal portion at a second frequency deviation level when a range-limited function is requested.

2. The system of claim 1 wherein the transmitter transmits the first and second signal portions at the first frequency deviation level when the command signal is not indicative of a range-limited function.

3. The system of claim 1 wherein the first frequency deviation level provides greater receiver sensitivity than the second frequency deviation level.

4. The system of claim 1 wherein the transmitter generates the wireless control signal using a single power level.

5. The system of claim 1 wherein the receiver is disposed on a motor vehicle and the transmitter is a remote keyless entry fob.

6. The system of claim 5 wherein the remote keyless entry fob is an active remote keyless entry fob.

7. The system of claim 5 wherein the remote keyless entry fob is a passive remote keyless entry fob.

8. The system of claim 1 further comprising:
a transmitter input device for generating a command signal; and
a transmitter controller for determining whether a range-limited function is requested based on the command signal, the transmitter being electronically coupled to the input device and the transmitter.

9. A method of controlling a function, the method comprising:
generating a wireless control signal with a transmitter, the wireless control signal having first and second signal portions;
transmitting the first signal portion at a first frequency deviation level;
transmitting the second signal portion at the first frequency deviation level when a range-limited function is not requested;
transmitting the second signal portion at a second frequency deviation level when a range-limited function is requested; and
performing the function if a receiver detects and successfully decodes the first and second signal portions.

10. The method of claim 9 wherein the first frequency deviation level provides greater receiver sensitivity than the second frequency deviation level.

11. The method of claim 9 wherein the transmitter generates the wireless control signal using a single power level.

12. The method of claim 9 wherein the first signal segment is transmitted before the second signal segment.

13. The method of claim 9 wherein the transmitter is an active remote keyless entry fob.

14. The method of claim 9 wherein the transmitter is a passive remote keyless entry fob.

15. A method of controlling a vehicle function with a remote keyless entry system having a receiver disposed on a vehicle and a remote keyless entry fob having a transmitter and first and second input devices, the method comprising:
actuating at least one of the first and second input devices;
transmitting a first wireless control signal at a first frequency deviation level with the transmitter when the first input device is actuated;
transmitting a second wireless control signal having a first signal portion and a second signal portion, wherein the first signal portion is transmitted at a first frequency deviation level and the second signal portion is transmitted at a second frequency deviation level when the second input device is actuated;
implementing a first vehicle function when the first wireless control signal is received by the receiver and successfully decoded;
implementing a second vehicle function when the second wireless control signal is received by the receiver and successfully decoded;
wherein the first frequency deviation level provides greater receiver sensitivity than the second frequency deviation level.

16. The method of claim 15 wherein the first frequency deviation level corresponds to a maximum sensitivity of the receiver.

17. The method of claim 15 wherein the second frequency deviation level corresponds to a minimum sensitivity of the receiver.

18. The method of claim 15 wherein the first function includes at least one of locking a vehicle closure, closing a vehicle window, or starting a vehicle engine.

19. The method of claim 15 wherein the second function includes at least one of unlocking a vehicle closure or actuating a vehicle closure.

20. The method of claim 15 wherein the first signal portion is transmitted before the second signal portion.
